(19) United States
(12) Patent Application Publication
(10) Pub. No.: US 2007/0108759 A1
(43) Pub. Date: May 17, 2007

(54) Air freshening apparatus and method for increasing fragrance in headspace

(75) Inventor: Daniel M. D'Amico, South Salem, NY (US)

Correspondence Address: BUCHANAN INGERSOLL & ROONEY PC, P.O. BOX 1404, ALEXANDRIA, VA, 22313-1404, US

(73) Assignee: Belmay, Inc.

(21) Appl. No.: 11/599,778

(22) Filed: Nov. 15, 2006

Related U.S. Application Data
(60) Provisional application No. 60/736,913, filed on Nov. 15, 2005.

(51) Int. Cl. F16L 35/00; F16L 41/00

(52) U.S. Cl. 285/116; 285/117; 285/122.1

(57) ABSTRACT

Methods and compositions of increasing volatile organic compounds in a container are disclosed. In particular, the invention discloses methods and composition for increasing the concentration of volatile organic compounds in the headspace of a container for a candle, shampoo bottle, or other product whose suitability for purchase is at least partially evaluated based on smell. Methods or compositions of the invention include the novel use of fragranced ethyl vinyl acetate in a variety of forms. The invention also includes a novel container for distribution of both a passive air freshener and a liquid spray air freshener.

### CROSS-REFERENCE TO RELATED APPLICATIONS

This application claims priority to pending U.S. Provisional Application No. 60/736,913, filed on Nov. 15, 2005. That application is incorporated by reference as if fully rewritten herein.

### STATEMENT REGARDING FEDERALLY SPONSORED RESEARCH OR DEVELOPMENT

Not applicable.

### BACKGROUND OF THE INVENTION

1. Field of the Invention

The invention relates to the fields of scent and aroma management. This includes but is not limited to increasing the amount of volatile organic compounds (fragrances) in the headspace above a solid or a liquid. This may also include but not be limited to a novel container for scent distribution, comprising a vented outer bottle containing a solid passive air freshener and enclosing an interior liquid reservoir. The interior liquid reservoir contains a fragrance that is, for example, identical to or complementary to that of the solid passive air freshener. The interior liquid reservoir communicates with a dispensing nozzle, for instance a spray pump or aerosol nozzle. Embodiments of the invention may include a novel aerosol dome, where said dome acts as a passive air freshener by allowing fragrance to diffuse from a scented insert (for example, ethyl vinyl acetate) on the interior of the dome, through vents in the dome. Optionally, the vents are ornamentally shaped.

2. Background

Many foods and consumer products either enhance their appeal or rely almost entirely for their appeal on fragrances. Generally, fragrances are volatile organic compounds that diffuse into the atmosphere under ambient temperature and pressure and enter the nasal cavity, triggering a receptor.

Diffusion of fragrances and their general intensity is governed by their equilibrium vapor pressure. Fragrances with a high equilibrium vapor pressure have a high volatility and quickly evaporate. This high volatility can create a large concentration of fragrance molecules in the “headspace” of a capped container. “Headspace” is the area above a solid or liquid in a container. In instances where a consumer opens a container (such as, for example, but not limited to, a candle jar, shampoo bottle, or conditioner bottle) and attempts to smell a product within that container, it is the fragrance in the headspace that the consumer smells. Generally, more powerful fragrances (i.e. fragrances with a large concentration in the headspace) are perceived as more desirable to consumers.

Evaluation of fragrance, including that in the headspace, is only one element that a consumer may use when making purchasing decisions. For example, when purchasing a candle, consumers may evaluate both visual qualities and such things as “cold throw.” “Cold throw” is the amount of volatile organic compound above a candle before it is lit. Cold throw may also be used to evaluate the efficacy of a passive air freshener. Passive air fresheners are those that rely on volatility at ambient temperature, which active air fresheners are those that may rely on both volatility at ambient temperature and increased volatility from the addition of heat or mechanical energy.

Because increased fragrance arid visual appeal are both important for increasing desirability of a product prior to purchase and utility of a product after purchase, it is desirable to increase the amount of volatile organic compounds (fragrance) in the headspace of a product. It is further desirable to find a way to increase the amount of fragrance in a manner that is also aesthetically pleasing. It would be further desirable to provide a cap or dome that may act as an independent passive air freshener.

Previous attempts to increase the amount of scented substance in headspace have been reported. U.S. Pat. No. 6,394,264, to Riviello, Jr., reports a device that includes a cap liner element for carrying a volatile substance and a barrier element that is lodged between the cap liner element and the interior of the container. The barrier element reported by the '264 Patent is permeable to the vapors of the volatile substance but impermeable to the consumer product. The device of the '264 Patent is purportedly suitable for use when the consumer product does not impart a pleasing aroma to the headspace, and when the consumer product further is chemically unsuited for direct addition of fragrance.

United States Published Patent Application No. US2004/0018293, to Poppelwell, et al., reports a packaging containing fragrance that is used to transfer fragrance to a food product. The '293 Publication also purports to use a sachet of absorbed flavor material, a flavor diffusing granule, or an “active system” for delivering vapor to a food environment.

There has also been recognized in the fragrance arts a need to enhance the fragrance distributed by an aerosol spray. For example, U.S. Pat. No. 6,413,476, to Barnhart reports that “scented aerosol sprays are initially overpowering and their effectiveness quickly deteriorates. They must be continually expelled to achieve desired results and can be irritating and offensive to the user.”

Apparatuses used for distribution of fragrance vary. Fragrance may be distributed in a liquid form by an aerosol system or a simple spray pump. Fragrance may also be distributed through a vented container that includes a solid air freshener that is exposed to air and deteriorates as its fragrance is released.

### BRIEF SUMMARY OF THE INVENTION

In one aspect, the invention includes mixing a fragrance or fragrance with a substance that absorbs and subsequently releases fragrance. For example, fragrance may be mixed with a polymer. In one aspect of the invention, ethyl vinyl acetate may be mixed with fragrance. After mixture with a fragrance, the substance may be shaped into a pleasing and/or functional form that is placed in the headspace or dome of the container. No barrier or sachet is necessary.

In one aspect of the invention, ethyl vinyl acetate (which may be, but is not required to be, in a roughly spherical shape) is mixed with fragrance then included in a cap of a container. The container may be, for example, but is not limited to a candle jar or shampoo bottle. The top of the container may then be sealed by a permeable membrane capable of releasing fragrance from the top of the container and into the headspace of the bottle or jar below. In a further aspect of the invention, the fragranced microspheres are colored and/or fused into a pleasing color and/or shape prior to insertion into a container top; a transparent or translucent container top may then be used to increase aesthetic appeal. By “microspheres” it is meant the approximately spherical units with diameters between about 3 mm and 12 mm.

In a further aspect of the invention, a container top as described above may be used a separate passive air freshener. This passive air freshener may supplement other fragrances distributed by the container, or it may act in their absence. If further fitted with a device to impart heat energy and/or mechanical energy, the container top may function as an active air freshener.

In a further aspect, a cap may be designed to connect to a top. This cap could act as a vented retainer for fragranced polymer. For example, a polypropylene cap may snap into a conventional jar candle lid. In a further embodiment, a vented dome is provided. Included on the interior of the vented dome is a fragranced polymer. For example, fragranced ethyl vinyl acetate as described herein is placed in the interior of the dome. When the vents are unsealed (for example, by removal of a decal, which may be able to be reapplied), the fragrance diffuses into the environment, allowing the vented dome to act as a passive air freshener.

The scent of the passive air freshener may be the same as or different from the scent in the associated active air freshener. The vents may be in any one or more of multiple shapes that may be ornamental, and these shapes may optionally correspond with the fragrance included in the active or passive air freshener, or they may correspond with the fragrance that the manufacturer would like to evoke. Such shapes include, for example, but are not limited to, slots, circles, ovals, parallelograms, apples, oranges, cherries, pears, bananas.

In a still further aspect of the invention, rather than inclusion in a container cap or lid in the shape of spheres or the like, a substance including a fragrance may be shaped into a form that is also functional in a container. For instance, ethyl vinyl acetate may be imparted with fragrance, then formed into a shape such as a disk gasket, O-ring, garden hose-type gasket or the like. Such a fragranced shape may have functionality (for example, as a seal) while still increasing the amount of fragrance in the headspace.

In another aspect, a gasket is formed from polypropylene including about 5% fragrance by weight. Such a seal or gasket may further be designed so that a portion of the gasket is outside the edge of, for example, a candle jar, thereby increasing fragrance both inside and outside the jar.

In a yet still further aspect of the invention, a substance including a fragrance may be used to ornament an object. For instance, ethyl vinyl acetate may be mixed with a fragrance, then melted, placed on an object, and allowed to harden. This may be facilitated, for example, by use of what is commonly known as a glue gun. A glue gun including fragranced ethyl vinyl acetate may be used to place an amount of the substance within the interior of a cap, for example a shampoo cap. Fragranced ethyl vinyl acetate may be placed in an aesthetic pattern either inside a transparent or translucent container, for instance in the headspace of a candle jar, or may be placed on the outside of a container either randomly or in a design. When placed inside the headspace, such a composition increases fragrance in the headspace and may make an object more aesthetically pleasing. Candles that may be used in the invention are described, for example, in United States Patent Application Publication No. 2004/0031191, to D'Amico, et al., and U.S. Pat. Nos. 2,726,526; 3,645,705; 5,171,329; 5,773,091; 5,879,694; 6,063,144; 6,221,115; 6,284,007; 6,296,674; and in Ulmann's Encyclopedia of Industrial Chemistry, Volume A5 at pages 29-30, all of which are incorporated by reference as if fully rewritten herein.

In a still further aspect of the invention, the invention includes a novel container for scent distribution. The container includes a vented outer bottle that contains a solid air freshener, as well as an interior liquid reservoir for an air freshener composition or other liquid. In one aspect, the interior bottle is in communication with a distribution apparatus. The substance in the interior bottle and the substance in the vented outer bottle may have complementary fragrances or identical fragrances. The distribution apparatus may be, for example, but is not limited to, a metered spray pump or an aerosol spray head. Of course, those skilled in the art will recognize that the fragrance aspect and the container aspect described herein may be practiced separately or in combination with each other.

### BRIEF DESCRIPTION OF THE DRAWINGS

FIG. 1 shows a candle jar including a top of the invention, including fragranced and fused ethyl vinyl acetate beads of the invention.

FIG. 2 shows a combination static (passive) and active room air freshener of the invention.

FIG. 3 also shows a combination static and active room air freshener of the invention.

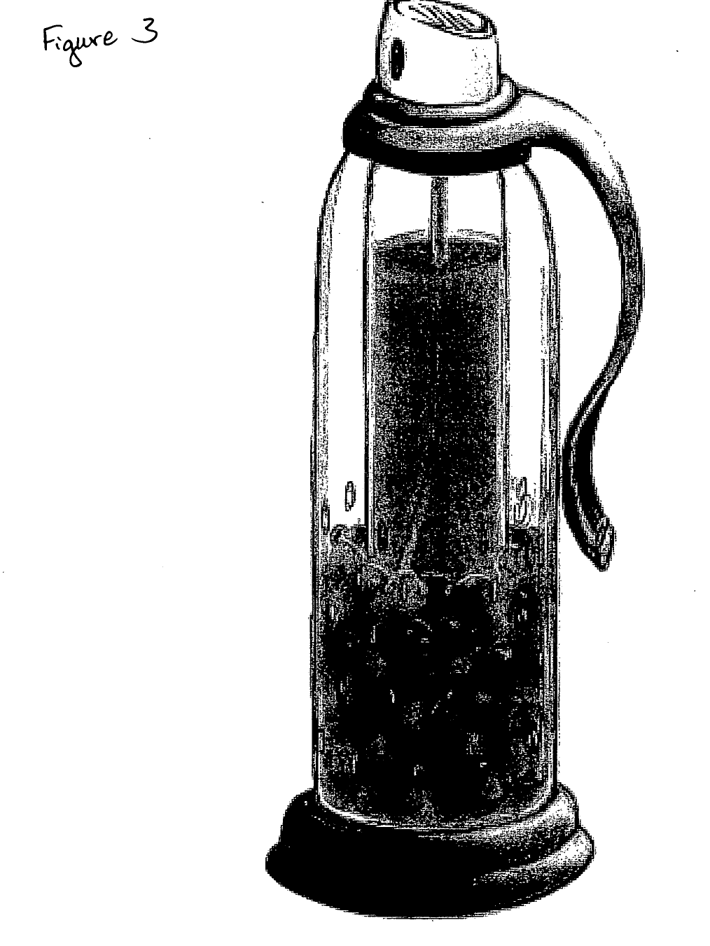

FIG. 4 is a depiction of a vented cap including a fragranced polymer insert of the invention.

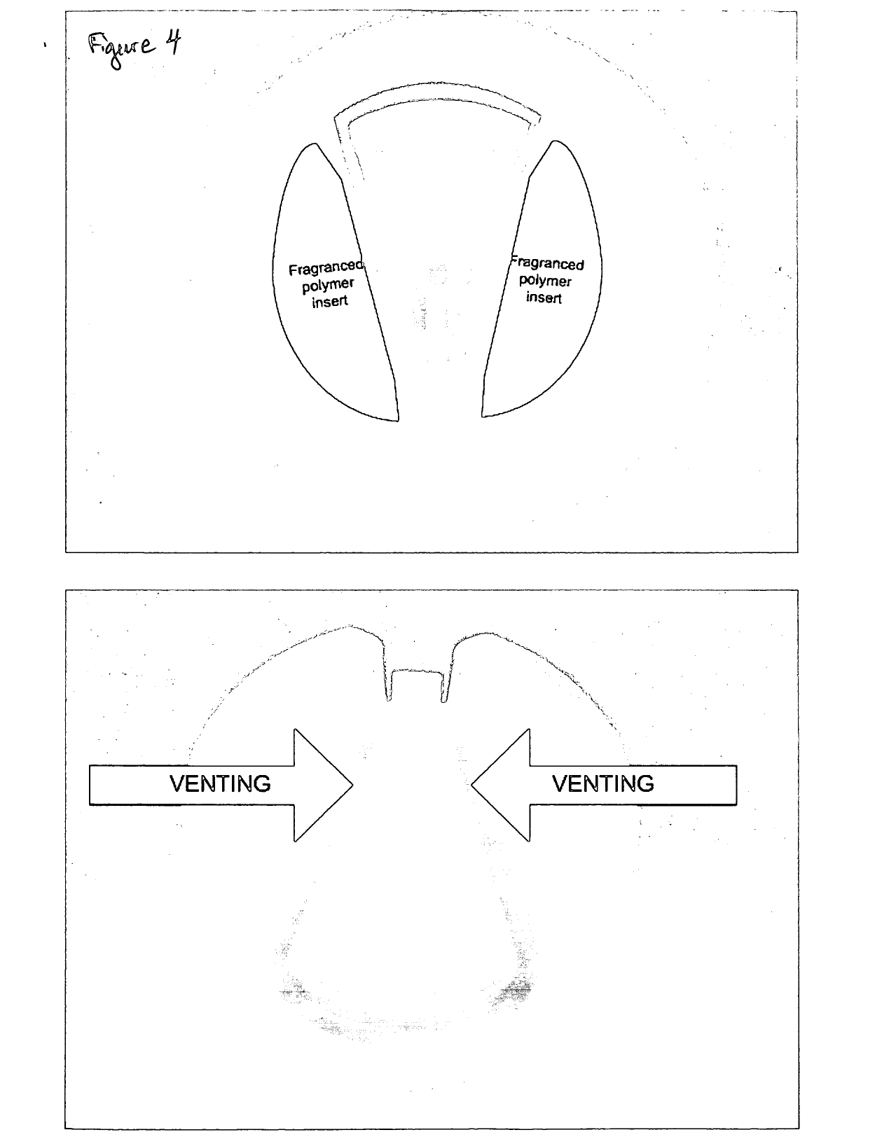

FIG. 5 shows an exemplary lid or top design, including a fragrance loaded polypropylene gasket. This design allows some fragrance cold throw outside the jar.

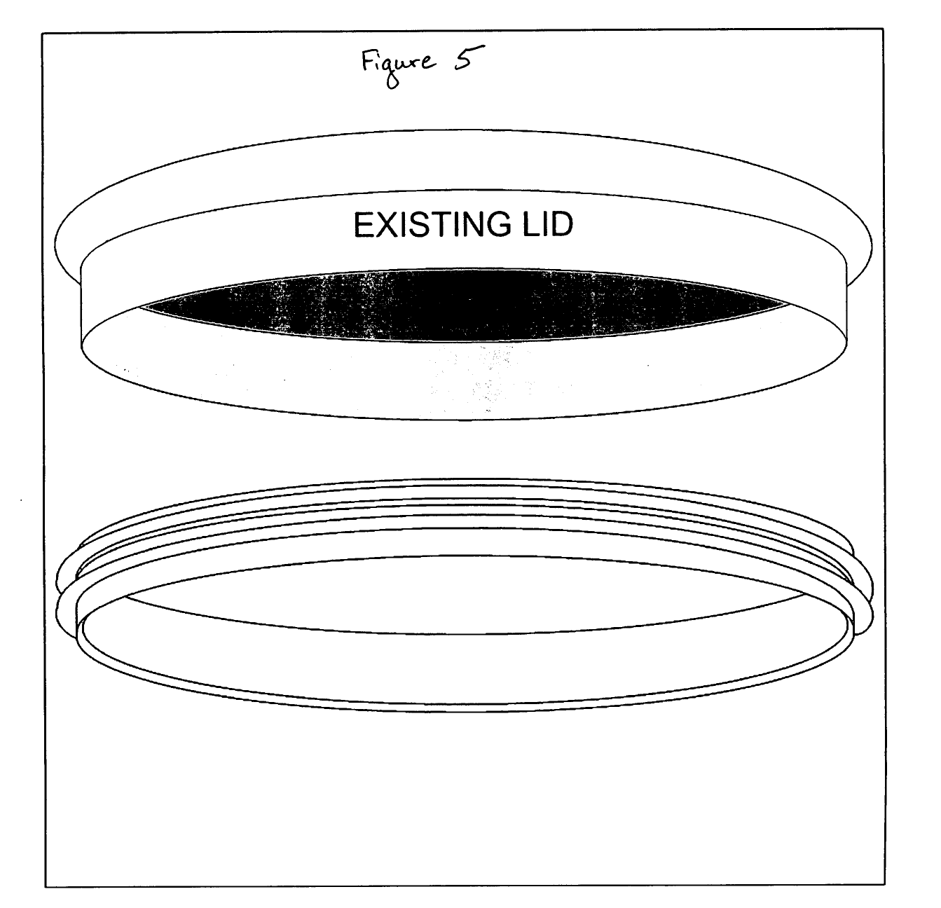

FIG. 6 shows a candle jar including a topper with scent-loaded polymer.

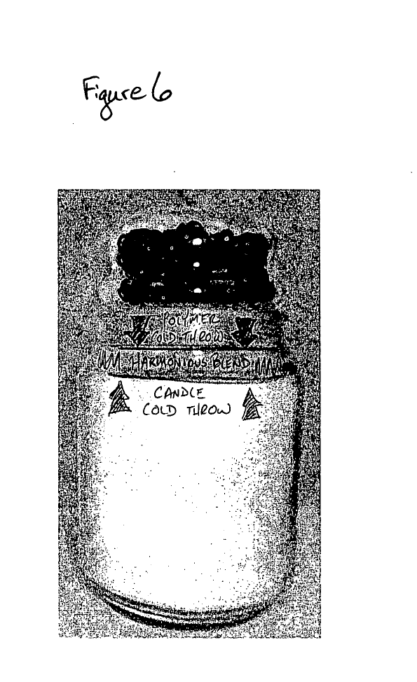

FIG. 7 shows another embodiment, in which a vented cap (which may be, for example, but is not limited to, polypropylene) is attached to an existing lid to serve as a retainer for fragranced beads.

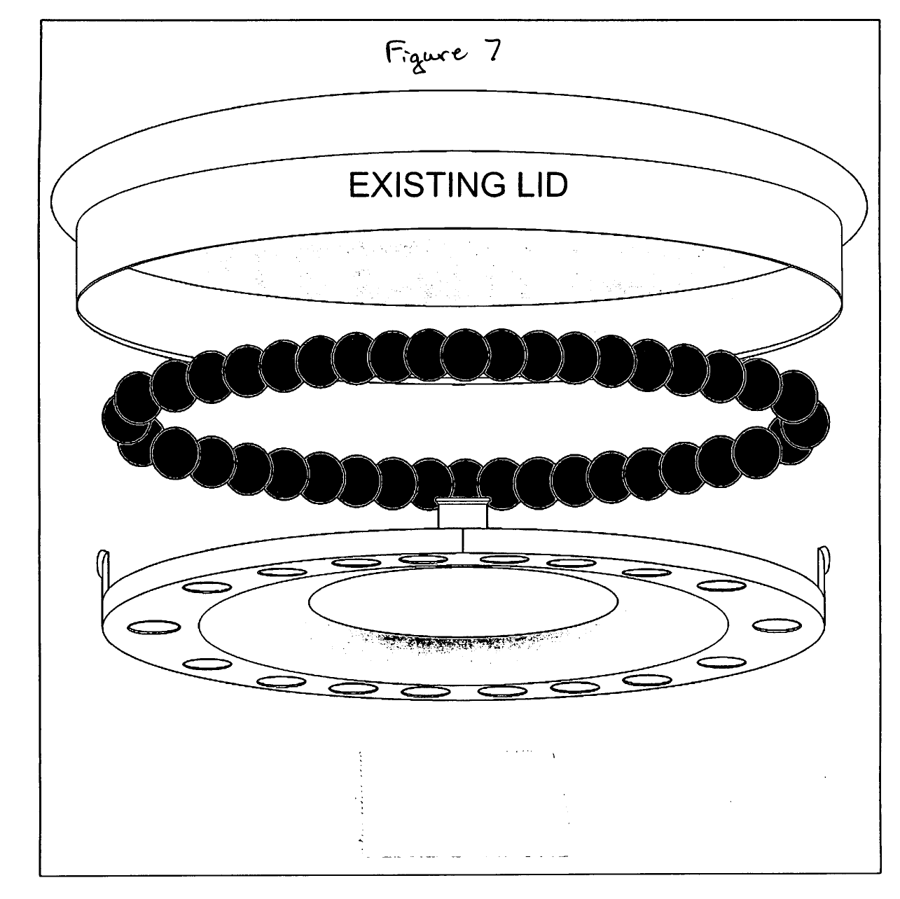

FIG. 8 shows a candle lid including fragranced polymer in a PVC dome sealed to a perforated plastic or foil backing. A sealing lip may be used to retain a gasket. The gasket may be polypropylene, and it may be scented as taught herein.

FIG. 9 shows the side view (A) of a candle topper of the invention, as well as an overhead view (B) of a vented enclosure for beads.

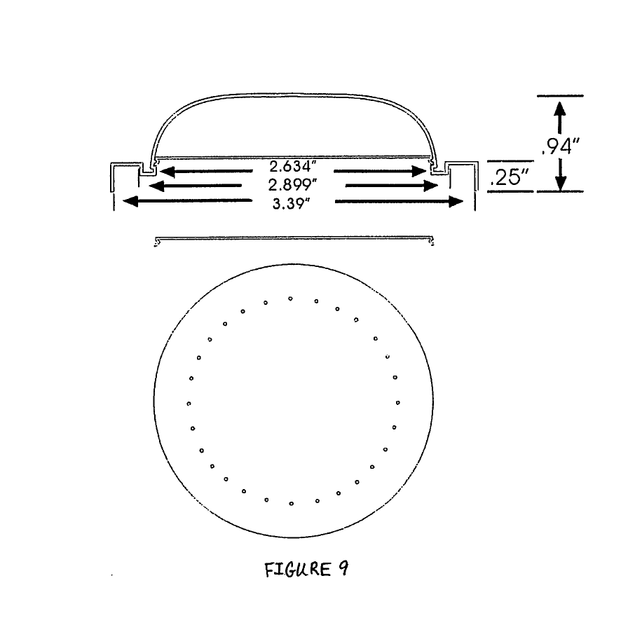

FIG. 10 shows a vented aerosol dome (A). The vents place the interior of the dome in communication with the environment. The interior of the dome includes a fragranced polymer.

### DETAILED DESCRIPTION OF THE INVENTION

Although the invention is described in several aspects and embodiments below, those skilled in the art will, with the benefit of this disclosure, recognize additional aspects, embodiments, and advantages that are within the bounds of the claims.

I. Headspace Fragrance Enhancement

In a first aspect of the invention, at least one fragrance is selected. The selected fragrance may be added to the headspace of an article of the invention. In one aspect the fragrance is selected to match that already in the headspace, while in a further aspect the fragrance may be selected to complement or counteract any fragrance existing in the headspace. Fragrances suitable for use in the invention include Cherry Jubilee, Watermelon, Starry Night, Vanilla Breeze, Fresh and Clean, Wildflowers. These fragrances were provided by Belmay, Inc. Other suitable fragrances include, for example, but are not limited to, those listed by the U.S. Food and Drug Administration in Title 21 of the Code of Federal Regulations, Sections 172.510 and 172.515 respectively, which are incorporated by reference herein. Suitable fragrance oils are, for example spice oil, flower oil, and fruit oil. Suitable fragrance chemicals are, for example benzaldehydes, phenols, cinnamic aldehydes and esters thereof, octadienes, dienes, cyclohexadienes, and terpenes. The fragrances may be introduced into the ethyl vinyl acetate at weight percents varying from 0.001% to 55%, from 0.01 to 50%, from 1 to 40%, from 5 to 40%, from 10 to 40%, from 20 to 40% and from 30 to 40%. In further embodiments, fragrance is introduced into ethyl vinyl acetate at a weight percent of about 1%, about 10%, about 20%, about 30%, or about 40%.

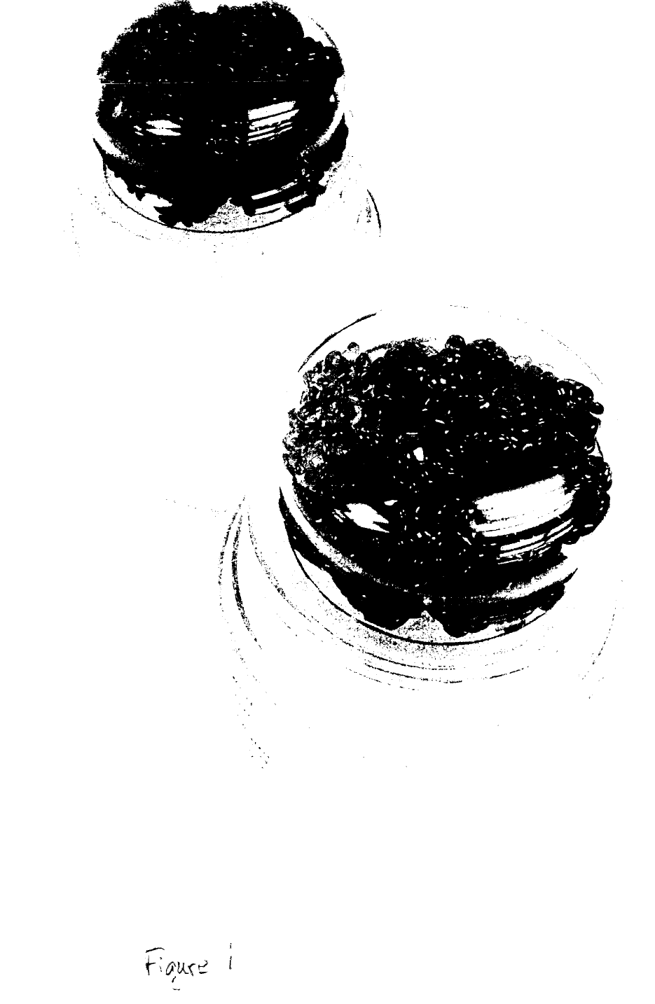

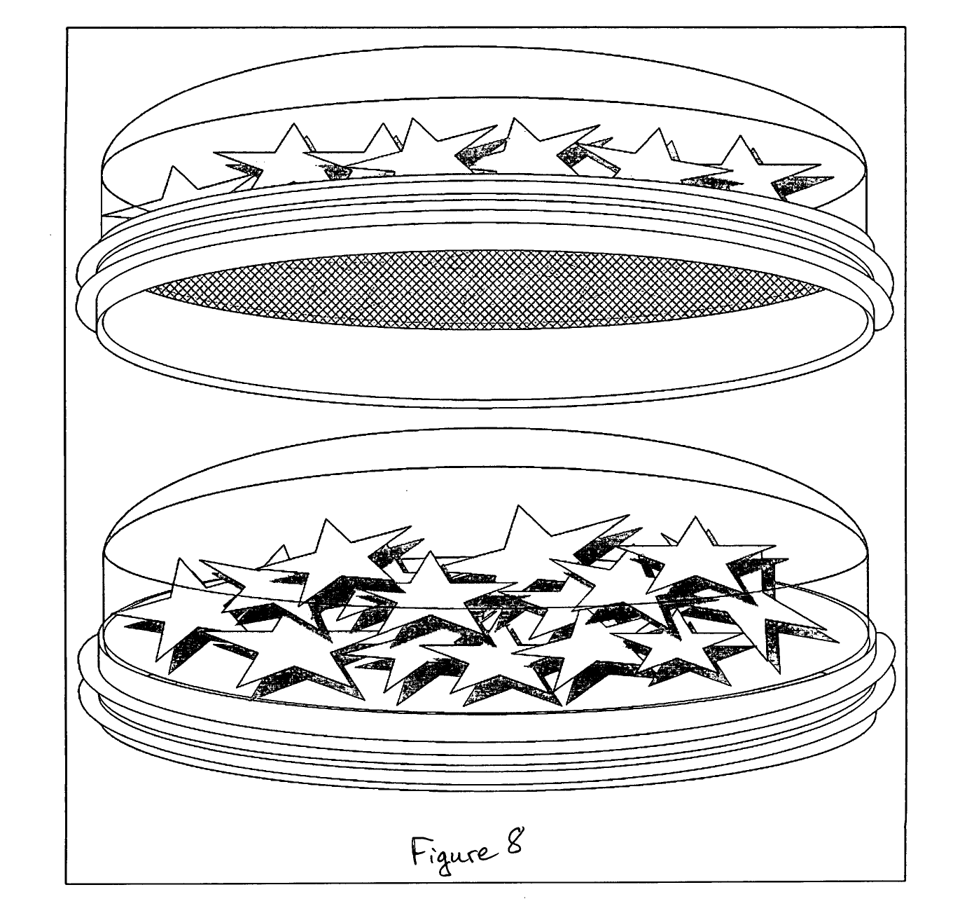

The invention contemplates mixture of a fragrance with a substance that will absorb fragrance and gradually release it into an environment. Such an environment may be a headspace. A suitable substance may also have properties that allow it to be formed into useful and/or ornamental shapes. Such shapes may be, for example, simulated “berries,” as shown in FIG. 1, or “stars” as shown in FIG. 8. Shapes may also have utility, such as gaskets or O-rings. In one aspect, the substance may be formed into a disk, though those skilled in the art will recognize that the polymer may be designed to avoid formation of a disk.

In one aspect of the invention, a suitable substance is a polymer. Suitable polymers may be, for example, but are not limited to, high and low density polyethylene, polystyrene, acrylic polymers, polycarbonates, various nylons, and others known to those skilled in the art. Mixtures and copolymers thereof may also be useful in the invention. In a further aspect of the invention, the polymer used is ethyl vinyl acetate (“EVA”). EVA used in the invention may have a molecular weight in the range of, for example, 10,000 Daltons to 100,000 Daltons, more preferably 22,000 to 87,000 Daltons.

In general, preparation of polymer/fragrance compositions of the invention is facilitated by the use of a solvent. Suitable solvents for use in the invention include but are not limited to isopar M, diisopropyl adipate, isopropyl myristate, benzyl benzoate, propylene glycol and others recognized by those skilled in the art with the benefit of this disclosure.

Those skilled in the art will recognize that a composition of the invention is not limited to inclusion of fragrance, polymer, and a solvent. Various additives may be included to add properties to the mixture or to enhance existing properties. For example, the mixture may include dyes, pigments, substances that improve fragrance absorption/emission, substances that make it more tacky for the “glue gun embodiment,” substances that help it keep its shape, help it be formed into a shape, or help with the fusion for the “berries,” extrusion enhancing additives, and injection molding enhancing additives. Both extrusion and injection molding additives suitable for use in the invention will be recognized by those skilled in the art.

Although applicants do not wish to be bound by theory, it is believed that the fragrance oil is absorbed into the polymer. This polymer slowly releases the fragrance in a controlled rate and releases most of the fragrance. The fragrance is not adsorbed since it would only be trapped on the surface of the polymer. Furthermore, the polymer when compressed, as in the bottle application, does not squeeze out the oil.

Fragranced EVA of the invention may be inserted into a device (such as a glue gun) that heats the EVA. This may cause the EVA to become viscous and adhesive. While in this state, the fragranced EVA may be applied to a suitable surface, where it may dry and adhere, imparting a pleasant scent. A suitable surface is any surface to which dried EVA will adhere. In one aspect of the invention, adhesive EVA may be applied to the inside of a cap for a bottle or other container. This allows the fragrance to diffuse into the headspace. It may also increase the overall cold throw of a candle or other scenting device.

The EVA may be applied as a coating, in a pattern, as a droplet, or as a plurality of droplets. In another aspect of the invention, the EVA may be dyed and applied in a decorative pattern. Application may be made either to the outside or to the inside of a container. If application is made to the inside of a container, preferably the container is transparent or translucent to allow the pattern to be viewed.

In a further aspect of the invention, a scented polymer is in the form of spheres. These spheres are optionally dyed and fused into clusters of various sizes. These clusters have a decorative quality and may be included in the top of a candle jar or in another container to impart their fragrance to a headspace. Such candle jar tops may further be designed with a cover, mesh, membrane, or other enclosure that may be sealed, unsealed, or fully or partially obstructed at the option of a user. Their undersides may be coated with tin or another heat-distributing substance. Candle jar tops or other container tops of the invention may therefore be used as stand-alone passive air fresheners. Candle jars of the invention may be less expensive than traditional glass candle jar lids. This adds value and function to a conventional candle jar or other container in which the invention is practiced. Of course, with the benefit of this disclosure those skilled in the art will recognize that modifications may be made to the tops that will allow them to function as active air fresheners; for example, a heating device may be included.

II. Combination Static and Active Air Freshener

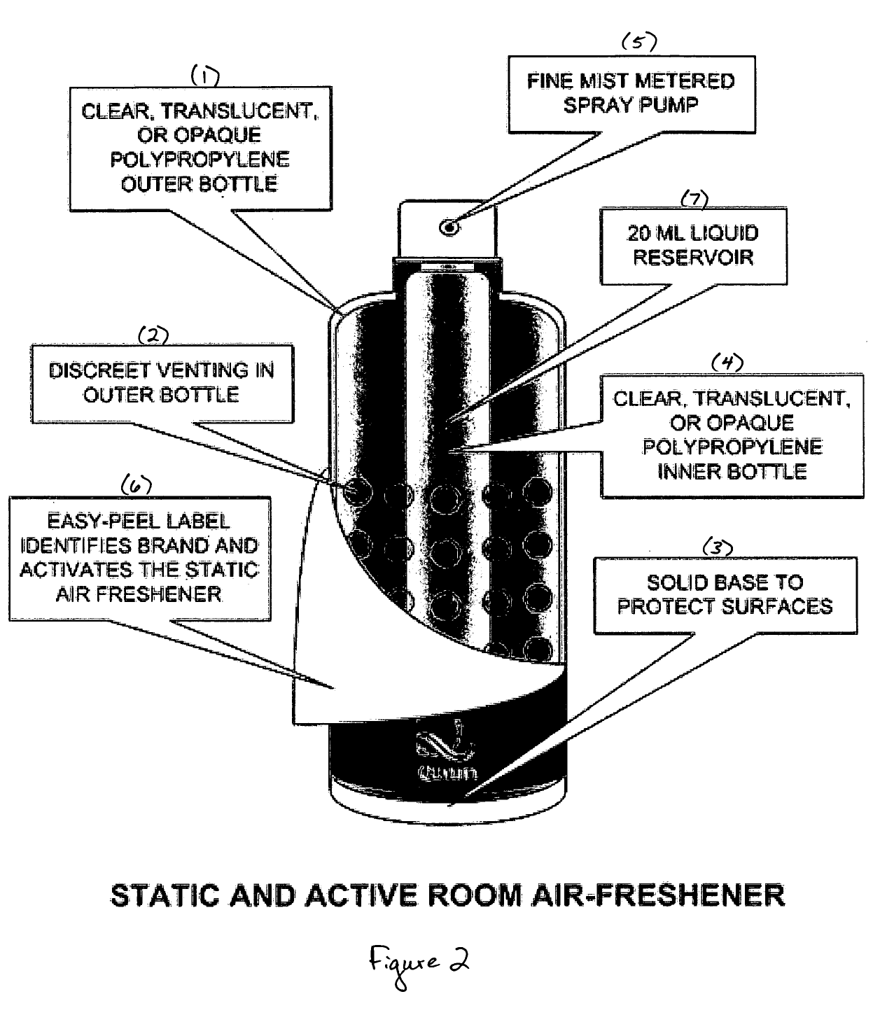

In another aspect, an embodiment includes a novel combination static and active air freshener. As seen, for example, in FIG. 2, a combination static and active air freshener of the invention may include an outer bottle 1, which includes a plurality of vents 2. Optionally, the outer bottle 1 includes a solid base 3 that may be used to protect surfaces onto which the air freshener is placed.

The outer bottle 1 further includes an inner bottle 4 defining a reservoir 7, which contains a fragrance in liquid form. The fragrance situated in the inner bottle may be distributed by a spray pump 5, which is situated on at the top of the combined outer bottle and inner bottle. The outer bottle optionally includes a label 6 that may be removed, either entirely or incrementally, to uncover the vents and activate the static air freshener. If present, the optional label may be designed to be replaced following use to preserve the fragrance of the static air freshener.

The inner and outer bottles may be made of the same material or different materials. Although not essential, polypropylene is a preferred material due to favorable properties such as strength and relative lack of reactivity. Materials may independently be selected from opaque, translucent, or transparent, and they may be any color.

Vents present in the outer bottle may be of any shape desired. One skilled in the art will recognize that the size and configuration of the vents may be varied as desired, so long as the solid air freshener allows the fragrance therein to diffuse at a desired rate.

A novel combination static and active air freshener of the invention may have many beneficial uses. For example, it may be used to provide a steady low level of fragrance to a room by way of the static air freshener, then additional fragrance may be released into the room by use of the liquid spray. The interior spray may be a room freshener or another beneficial fragrancing agent, such a linen refresher.

A variety of passive air fresheners are suitable for use in the outer bottle. These include fragranced EVA (as described above), gels, or other solid air fresheners.

A variety of liquid fragrances and carriers are suitable for use in the interior container. For instance, the interior container may contain a solvent-based aerosol air freshener, a water-based aerosol air freshener, a non-aerosol water-based air freshener, a hydroalcoholic air freshener, or a linen refresher. Although not meant to be limiting, examples of possible substances for inclusion in the inner bottle are listed below in Tables 1 through 5.

TABLE 1

| Solvent-Based Aerosol Air Freshener | % |
|---|---|
| SDA 39C | 61.0 |
| Triethylene Glycol | 4.0 |
| Fragrance | Q.S. |
| Propellant | 35 |

The air freshener is prepared by premixing 93.75% SDA 39C with 6.25% triethylene glycol, then combining this premix with propellant at a level of 65%.

TABLE 2

| Water-based Aerosol Air Freshener | % |
|---|---|
| C11-C12 Isoparaffin | 15.25 |
| (Isopar H, Exxon) | |
| Polyglyceryl-4 Oleate | 1.5 |
| (Witconol 14, Witco) | |
| Deionized water | 83.25 |
| Fragrance | Q.S. |

Combine Isopar H and Witconol 14. Mix until clear. Add water, mix to clarity. The concentrate is mixed with propellant in an amount yielding 65% concentrate and 35% propellant.

TABLE 3

| Non-aerosol Water-based Air Freshener | % |
|---|---|
| Octoxynool-9 | 6.00 |
| Dipropylene Glycol | 12.00 |
| Deionized Water | 82.00 |
| Fragrance | Q.S. |
| Preservatives, Color | Q.S. |

Presolubilize fragrance in Octoxynol-9 and Dipropylene Glycol at room temperature until clear and uniform. Add the remainder of the ingredients. Mix to clarity.

TABLE 4

| Hydroalcoholic Air Freshener | % |
|---|---|
| Nonoxynol-15 | 10.0 |
| (Igepal CO730, Rhone Poulenc) (Heat gently | |
| and mix thoroughly to a clear liquid before | |
| use.) | |
| SDA 40 | 15.0 |
| Fragrance | 5.0 |
| Deionized water | 70.0 |
| Color, preservatives, etc. | Q.S. |

Combine first three ingredients until clear and uniform. Add water, mix to clarity.

TABLE 5

| Linen Refresher | % |
|---|---|
| A | |
| Nonoxynol-15 | 3.0 |
| (Igepal CO730, Rhodia) | |
| Fragrance* | Q.S. |
| SDA 39C | 18.0 |
| B | |
| Deionized water | 70.0 |
| Methylpropanediol (MP Diol Glycol, Arco) | 10.0 |

The refresher is prepared by solubilizing the fragrance in alcohol and Igepal CO730. When clear and homogeneous, add B all at room temperature.
*Fragrance should be added at 0.6%-1.0%.

With the benefit of this disclosure, those skilled in the art will recognize that other additives, such as dyes, may be effective and/or pleasing when added to the fragrance compositions of the invention.

III. Vented Dome with Passive Air Freshener

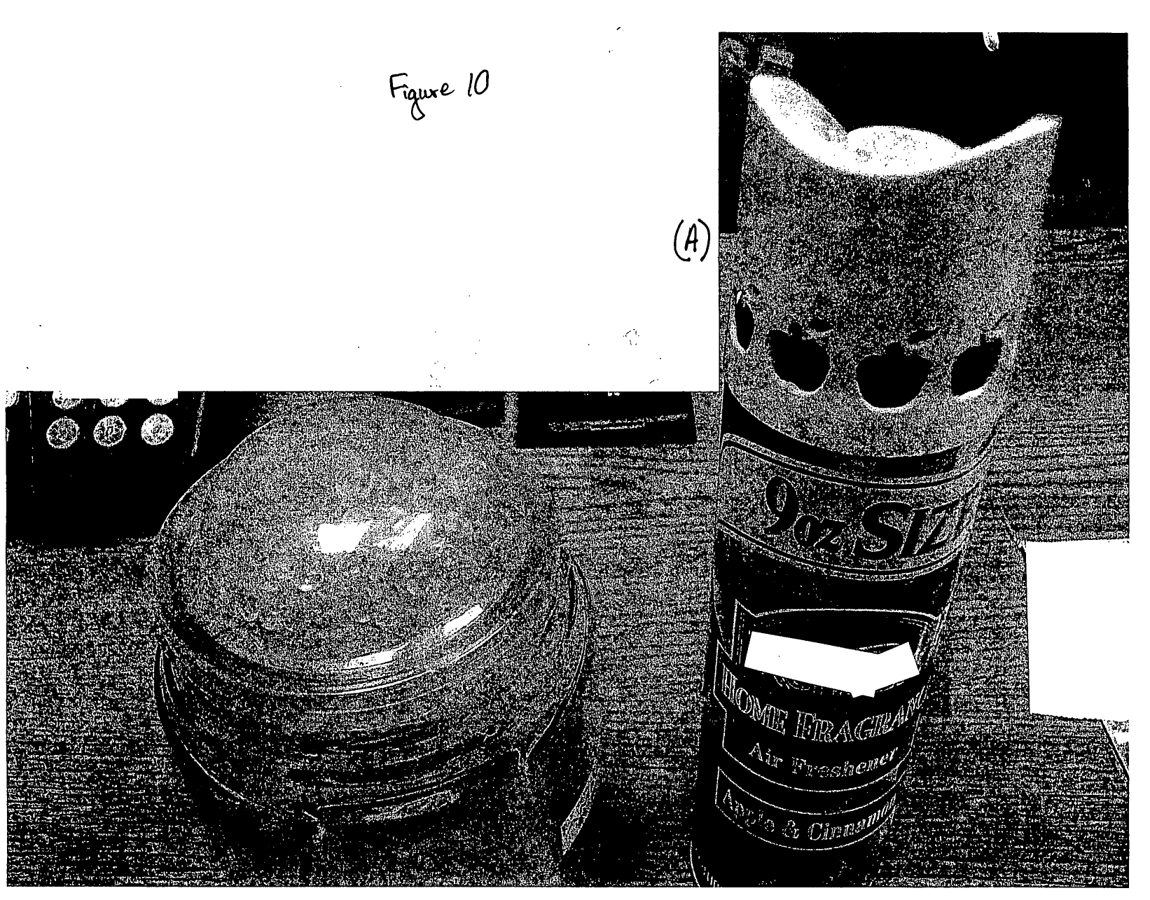

In another embodiment, the invention includes an aerosol container with a vented dome. A typical example is shown in FIG. 10. The vented dome includes a fragranced polymer as described herein, which may be adhered to at least one of the top and sides of the dome. The vented dome may contain one or more vents, which may be the same or different shapes. The vents may be disposed uniformly about the circumference of the dome, or their disposition may be non-uniform. The vents may be shaped to optimize certain aromatic characteristics. For example, smaller vents may decrease fragrance diffusion but increase the effective life of the passive air freshener, while larger vents may increase diffusion but lead to a shorter effective fragrance life.

Vent shapes may include, for example, but are not limited to, slots, circles, ovals, parallelograms, or two-dimensional representations of apples, oranges, cherries, pears, or bananas. Other shapes may be used depending on the desired rate of fragrance release and the desired aesthetic impression to be made. Shapes may be die-cut, or they may be extruded. Those skilled in the art will recognize that shapes may be formed in other ways known for shaping polymers.

In a further embodiment, the vents are situation about the circumference of the dome, and they are sealed. This seal may be, for example, a seal that may be removed a single time and not replaced, or it may be a seal that may be removed (fully or partially) and reapplied multiple times.

### EXAMPLES

1. Preparation of the Solvent/EVA/Fragrance Mixture

Make a mixture of solvent, fragrance, additives such as dyes, colorants, and performance enhancing additives if the enhancing additives are needed for production purposes. This liquid phase is added to the EVA using appropriate mixing equipment.

2. Use of the Solvent/EVA/Fragrance Mixture of Example 1 in a Candle Jar Top

The solvent/EVA/fragrance mixture in the Candle Jar Top is introduced into the cavity of the jar top as either spherical beads, extruded and dye cut shapes, or injection molded shapes. To keep the shapes or beads from falling out of the jar top a vapor permeable membrane is used. This permeable membrane may be made of various plastics as well as metal mesh or other materials known to those skilled in the art.

3. Use of the Solvent/EVA/Fragrance Mixture of Example 1 as a Shampoo Bottle Gasket

The gasket used in this application is made by extrusion and die cutting or is manufactured by injection molding. The molded shape may be as a solid disk to be used as a cap liner. Another gasket may take the shape of an “O” ring or a garden hose gasket.

I claim:

1. A method of increasing concentration of volatile organic compounds in or around a container comprising inserting into or attaching onto said container a composition a polymer, wherein said polymer is impregnated with a volatile substance and a solvent.

2. The method of claim 1, wherein said container further comprises a composition selected from the members of the group consisting of shampoo, conditioner, a combination shampoo/conditioner, and a candle.

3. The method of claim 1, wherein said polymer is selected from the group consisting of ethyl vinyl acetate (EVA), high and low density polyethylene, polystyrene, acrylic polymers, polycarbonates, various nylons, and combinations and copolymers thereof.

4. The method of claim 1, wherein said volatile substance is a fragrance.

5. The method of claim 1, wherein said volatile substance is selected from the group consisting of benzaldehydes, phenols, cinnamic aldehydes and esters thereof, octadienes, dienes, cyclohexadienes, and terpenes.

6. The method of claim 1, wherein said composition is included as a plurality of microspheres.

7. The method of claim 6, wherein said plurality of microspheres are fused in a plurality of groups of three or more microspheres per group.

8. The method of claim 1, wherein said container is a glass candle jar, and said polymer is ethyl vinyl acetate.

9. A cap for a container, wherein said cap comprises a fragrance on the interior of said cap, and wherein said cap includes at least one vent allowing flow of air between the interior and exterior of the cap.

10. The cap of claim 9, wherein said cap is an aerosol dome.

11. The cap of claim 9, wherein said cap further comprises a label sealing the at least one vent, wherein said label may be fully or partially removed to open one or more of the at least one vents.

12. The cap of claim 9, wherein said cap further comprises a polymer impregnated with said fragrance and a solvent.

13. The cap of claim 12, wherein said polymer is ethyl vinyl acetate.

14. The cap of claim 9, wherein said fragrance is selected from the group consisting of benzaldehydes, phenols, cinnamic aldehydes and esters thereof, octadienes, dienes, cyclohexadienes, and terpenes.

15. A container for dispensation of fragrance from both solid and liquid carriers, comprising:
(a) an outer container, said outer container comprising a plurality of vents placing the interior of said outer container in communication with the atmosphere, wherein said outer container includes a first fragrance disposed on a carrier; and
(b) an inner container, said inner container disposed within said outer container and containing a second fragrance dispersed in a fluid carrier, wherein the interior of said inner container is in communication with a dispensing apparatus.

16. The container of claim 15, further comprising a label on the exterior of the outer container, said label sealing said plurality of vents, and said label capable of being fully or partially removed to open one or more of said plurality of vents.

17. The container of claim 15, wherein said first fragrance and said second fragrance are the same or different, and wherein said first fragrance and said second fragrance are selected from the group consisting of benzaldehydes, phenols, cinnamic aldehydes and esters thereof, octadienes, dienes, cyclohexadienes, and terpenes.

18. The container of claim 15, wherein said dispensing apparatus is selected from the group consisting of a metered spray pump, an unmetered spray pump, and an aerosol nozzle.
